(19) United States
(12) Patent Application Publication
(10) Pub. No.: US 2014/0380016 A1
(43) Pub. Date: Dec. 25, 2014

(54) INFORMATION PROCESSING APPARATUS, CONTROL METHOD THEREOF, AND PROGRAM

(71) Applicant: CANON KABUSHIKI KAISHA, Tokyo (JP)

(72) Inventor: Daisuke Matsunaga, Yokohama-shi (JP)

(21) Appl. No.: 14/376,370

(22) PCT Filed: Nov. 19, 2013
(86) PCT No.: PCT/JP2013/081574

§ 371 Date: Aug. 1, 2014

(30) Foreign Application Priority Data
Nov. 29, 2012 (JP) 2012-261626

(51) Int. Cl. G06F 12/02; G06F 12/06

(52) U.S. Cl. CPC G06F 12/023; G06F 12/06
USPC 711/171

(57) ABSTRACT

An information processing apparatus of this invention calculates amounts of generated heat of respective areas of a plurality of areas of a SOC die when one or more function blocks required to execute an accepted job are operated, and preferentially allocates a memory area of a WideIO memory device stacked on a corresponding area to the function blocks to be operated in accordance with an order of areas corresponding to smaller calculated amounts of generated heat.

### TECHNICAL FIELD

The present invention relates to an information processing apparatus which includes a WideIO memory device stacked on a SOC die including a CPU, a control method thereof, and a program.

### BACKGROUND ART

An existing information processing apparatus generally uses a DRAM (Dynamic Random Access Memory) so as to store data required to execute an OS and various applications, and to temporarily store data required to execute image processing. This DRAM is connected to a CPU, SOC, and the like when it is used. Also, upon multiple and advanced functions of the information processing apparatus in recent years, a memory band of the DRAM is increased. The memory band is increased by raising a clock frequency of data accesses in standards such as DDR3 or DDR4. Also, the band is allocated by providing a plurality of DRAM channels connected to a CPU and ASIC.

However, the arrangement using a higher clock frequency and a plurality of memory channels poses a new problem, that is, an increase in power consumption. Hence, “WideIO” as the next generation DRAM standard currently receives a lot of attention. The WideIO is a memory technology which uses a 3D stacking technique based on TSV (Through Silicon Via), and stacks a DRAM chip on a SOC die. As features of the WideIO, a data width as wide as 512 bits and a high-frequency band of a maximum of 12.8 GB/sec or more are used, and low power consumption is guaranteed since an access frequency is suppressed to low. Also, since the TSV is adopted, a package size can be reduced and smaller than the conventional PoP (Package on Package). As further detailed features, a temperature sensor is integrated as a countermeasure against heat due to stacking in a SOC package, and a self refresh rate is changed depending on the temperature. As still another feature, the data width (512 bits) is divided into four channels of 128 bits, and respective channels are independently controlled. For example, in one use method, channels 1 and 2 are set in a self-refresh state, and channels 3 and 4 are normally used. US Patent Application Publication No. 2012/0018885 has proposed a technique related to the basic structure and basic access method of such WideIO.

However, the related art suffers the following problems. The stacked structure of the WideIO is susceptible to heat in terms of the structure. For example, when a specific area of a die and a WideIO DRAM located on an upper layer portion of this specific area are simultaneously activated, the activated portion locally causes a temperature rise. Then, a semiconductor leak current, which exponentially rises with respect to the temperature, is increased, resulting in an increase in power consumption. Also, the DRAM stores data by storing charges in capacitors included in respective cells. Since this capacitor naturally discharges due to the semiconductor leak current, the DRAM is required to discharge the capacitors by a refresh operation. This discharge depends on the temperature, and a discharging speed is higher as the temperature is higher. Therefore, when the temperature rises, a refresh frequency is required to be increased, resulting in an increase in power consumption and an access performance drop of the DRAM caused by an inaccessible state of the DRAM during the refresh operation.

### SUMMARY OF INVENTION

The present invention enables realization of a mechanism which lightens a local temperature rise due to an elapse of time, and reduces a refresh frequency and leak current of a DRAM.

One aspect of the present invention provides an information processing apparatus, which comprises a WideIO memory device stacked on a SOC die including a CPU, the apparatus comprising: accepting means for accepting a job; calculation means for calculating amounts of generated heat of respective areas of a plurality of areas of the SOC die when one or more function blocks required to execute the job accepted by the accepting means are operated; and memory control means for preferentially allocating a memory area of the WideIO memory device stacked on a corresponding area to the function blocks to be operated in accordance with an order of areas corresponding to smaller amounts of generated heat calculated by the calculation means.

Another aspect of the present invention provides a control method of an information processing apparatus, which comprises a WideIO memory device stacked on a SOC die including a CPU, the method comprising: controlling accepting means to accept a job; controlling calculation means to calculate amounts of generated heat of respective areas of a plurality of areas of the SOC die when one or more function blocks required to execute the job accepted in the controlling the accepting means are operated; and controlling memory control means to preferentially allocate a memory area of the WideIO memory device stacked on a corresponding area to the function blocks to be operated in accordance with an order of areas corresponding to smaller amounts of generated heat calculated in the controlling the calculation means.

Further features of the present invention will be apparent from the following description of exemplary embodiments with reference to the attached drawings.

### BRIEF DESCRIPTION OF DRAWINGS

FIG. 1 is a block diagram showing the overall arrangement of an MFP (digital multi functional peripheral) according to the first embodiment;

FIGS. 2A and 2B are views showing the structure of a WideIO-SDRAM according to the first embodiment;

FIG. 3 is a block diagram showing the internal arrangement of a WideIO controller according to the first embodiment;

FIG. 4 is a block diagram showing the detailed arrangement of function blocks having external I/Fs according to the first embodiment;

FIG. 5 is a perspective view showing the physical positional relationship of WideIO-SDRAM channels and a SOC die according to the first embodiment;

FIG. 6 is a view showing allocated addresses of the WideIO-SDRAM according to the first embodiment;

FIG. 7 is a view showing allocated addresses of the WideIO-SDRAM according to the first embodiment;

FIG. 8 is a table showing function blocks allocated to respective divided areas of the SOC die according to the first embodiment, and relative amounts of generated heat when the function blocks are activated;

FIG. 9 is a flowchart showing a decision method of an address area to be allocated according to the first embodiment;

FIGS. 10A and 10B are flowcharts showing a decision method of an address area to be allocated according to the second embodiment; and

FIGS. 11A and 11B are flowcharts showing a decision method of an address area to be allocated according to the third embodiment.

### DESCRIPTION OF EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise. Note that an MFP (digital multi functional peripheral) having a plurality of functions such as scan, printer, and copy functions will be exemplified below as an information processing apparatus including the WideIO according to this embodiment.

### First Embodiment

### Arrangement of Information Processing Apparatus

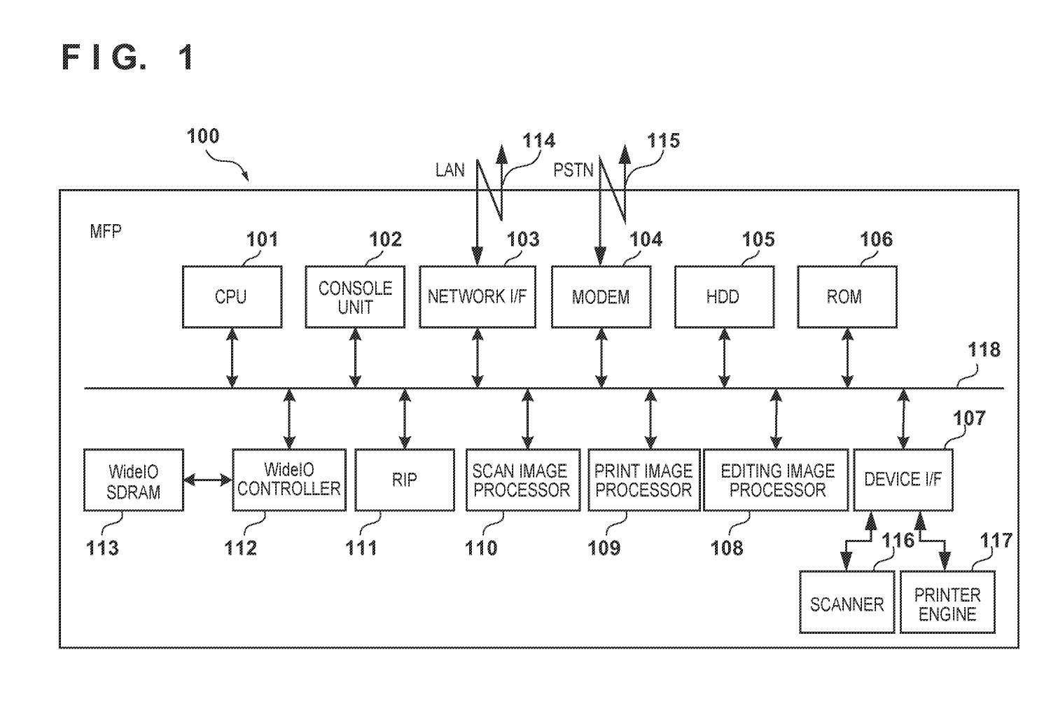

The overall arrangement of an MFP (digital multi functional peripheral) according to this embodiment will be described first with reference to FIG. 1. This embodiment will exemplify an MFP (Multi Functional Peripheral) as an information processing apparatus. An MFP 100 has a scanner 116 as an image input device and a printer engine 117 as an image output device, which are connected to a system bus 118 via a device interface (I/F) 107. Then, under the control of a CPU 101, an original image reading operation of the scanner 116 and a print operation of the printer engine 117 can be executed. The MFP 100 is connected to a LAN 114 and a public network (PSTN) 115, and can exchange device information and image data of external devices connected to the LAN or public network via them.

The CPU 101 controls the operation of this MFP 100 by executing a program, which is read out from an HDD 105 and is expanded onto a WideIO-SDRAM 113 by a boot program stored in a ROM 106. An operation unit 102 includes an input unit such as a keyboard and touch panel, and a display unit, accepts a user instruction, and displays a message for the user, processing results, and the like on the display unit. A network I/F 103 is implemented by, for example, a LAN card or the like, and exchanges device information and image data with an external device via the LAN 114. A modem 104 exchanges control information and image data with an external device via the public network 115. The HDD 105 is a hard disk drive, stores an OS, various application programs, and the like, and also stores input image data and the like. The ROM 106 stores the boot program and various data. The device I/F 107 connects the scanner 116 and printer engine 117, and executes transfer processing of image data between these scanner 116 and printer engine 117, and the system bus 118.

An edit image processor 108 executes various kinds of image processing such as rotation and zooming, color processing, trimming/masking, binary conversion, multi-value conversion, and blank paper determination of image data. A print image processor 109 applies image processing according to the printer engine 117 to image data to be output to the printer engine 117. A scan image processor 110 applies various kinds of processing such as correction, modification, and editing to image data input from the scanner 116. A RIP (Raster Image Processor) 111 rasterizes page description language (PDL) code data into image data. A WideIO controller 112 converts a memory access command from, for example, the CPU 101 and each image processor into a command interpretable by the WideIO-SDRAM 113, and accesses the WideIO-SDRAM 113. The WideIO-SDRAM 113 stores a program to be executed by the CPU 101, and provides a system work memory required for the CPU 101 to operate. Also, the WideIO-SDRAM 113 is an image memory used to temporarily store input image data. The system bus 118 connects the aforementioned respective units and the CPU 101, and transfers control signals, data, and the like.

<Arrangement of WideIO-SDRAM>

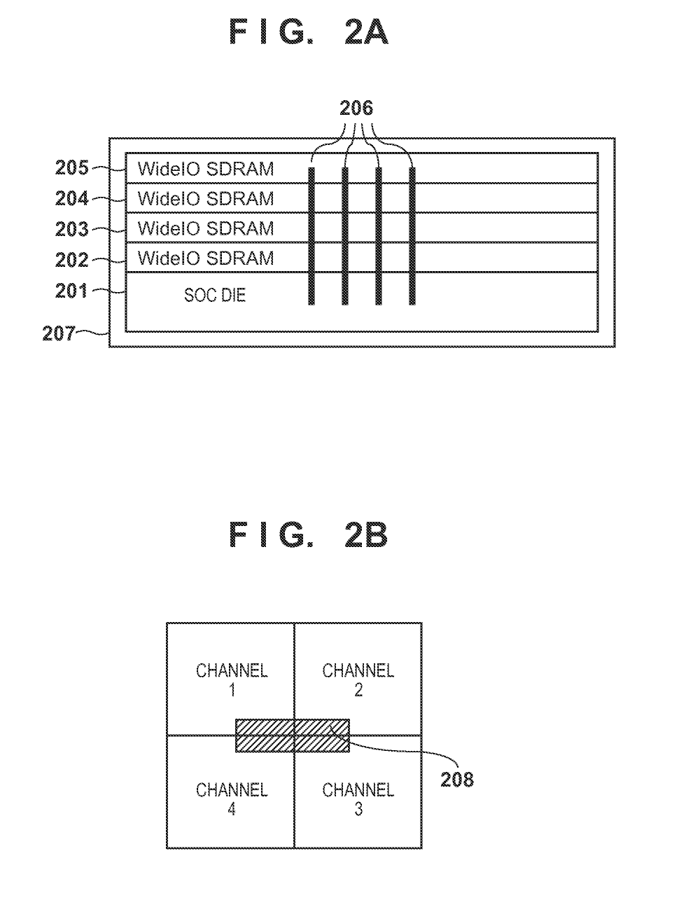

The structure of the WideIO-SDRAM 113 as a WideIO memory device according to this embodiment will be described below with reference to FIGS. 2A and 2B. FIG. 2A is a side view of the WideIO-SDRAMs and a SOC die when viewed from the side surface side, and FIG. 2B is a top view when viewed from the top side.

A SOC die 201 includes, for example, the CPU 101, device I/F 107, RIP 111, image processors 108 to 110, and the like in the first embodiment. WideIO-SDRAMs 202 to 205 are stacked on the SOC die 201, and are connected to the SOC die 201 via through silicon vias (TSVs) 206. A maximum of four layers of WideIO-SDRAMs can be stacked according to a required memory capacity, and FIG. 2A shows an example in which four layers are stacked. A SOC package 207 houses the SOC die 201 and WideIO-SDRAMs 202 to 205 in a single package. A WideIO-SDRAM I/F 208 is arranged at the central portion of the SOC die 201 and the WideIO-SDRAMs 202 to 205, as shown in FIG. 2B.

<Arrangement of WideIO Controller>

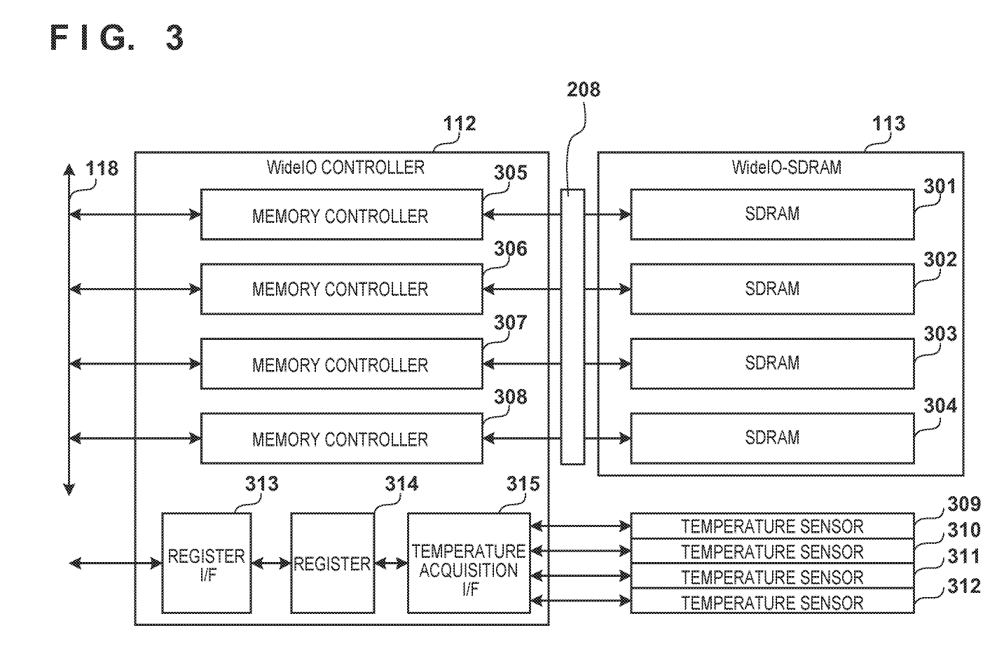

The internal arrangement of the WideIO controller 112 according to this embodiment will be described below with reference to FIG. 3. Referring to FIG. 3, the WideIO controller 112 is connected between the system bus 118 and WideIO-SDRAM 113, as shown in FIG. 1. Furthermore, the WideIO controller 112 is connected to temperature sensors 309 to 312 which are not shown in FIG. 1.

SDRAMs 301 to 304 are four memories arranged in the WideIO-SDRAM 113, and respectively include dedicated interfaces, as shown in FIG. 3. These dedicated interfaces correspond to four channels of the WideIO-SDRAMs 202 to 205 stacked on the SOC die 201, as described above, and correspond to the WideIO-SDRAM I/F 208 shown in FIG. 2B. Each of memory controllers 305 to 308 converts a memory access command from the system bus 118 into a command interpretable by the corresponding connected SDRAM, and accesses that SDRAM. The temperature sensors 309 to 312 measure the temperatures of the corresponding SDRAMs 301 to 304.

A register I/F 313 accepts accesses from the CPU 101 via a register dedicated bus (not shown). A register 314 stores respective pieces of temperature information acquired by a temperature acquisition I/F 315 from the temperature sensors 309 to 312, and pieces of setting information of respective operation modes of the memory controllers 305 to 308, which are set by the CPU 101.

<Arrangement of Function Blocks>

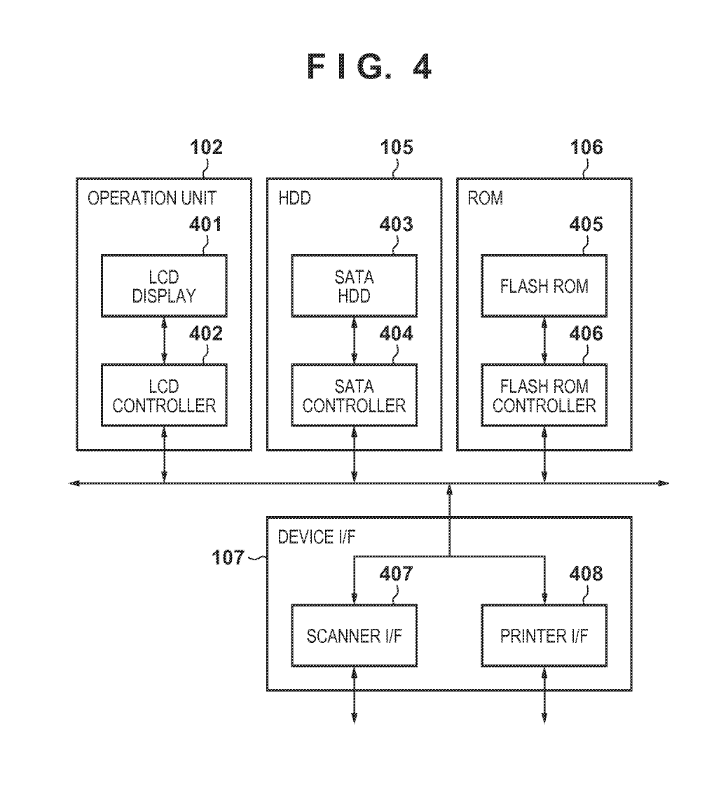

The detailed arrangement of function blocks such as the operation unit 102, HDD 105, ROM 106, and device I/F 107, each of which includes an external I/F controller and external device, will be described below with reference to FIG. 4. The operation unit 102, HDD 105, and ROM 106 respectively include various general-purpose I/F controllers, that is, an LCD controller 402, SATA controller 404, and Flash ROM controller 406. Likewise, the operation unit 102, HDD 105, and ROM 106 respectively include general-purpose devices controlled by the general-purpose I/F controllers, that is, an LCD display 401, SATA HDD 403, and Flash ROM 405. Also, the device I/F 107 includes a scanner I/F 407 and printer I/F 408, which exchange control signals and image data with devices, that is, the scanner 116 and printer engine 117.

<SOC Package>

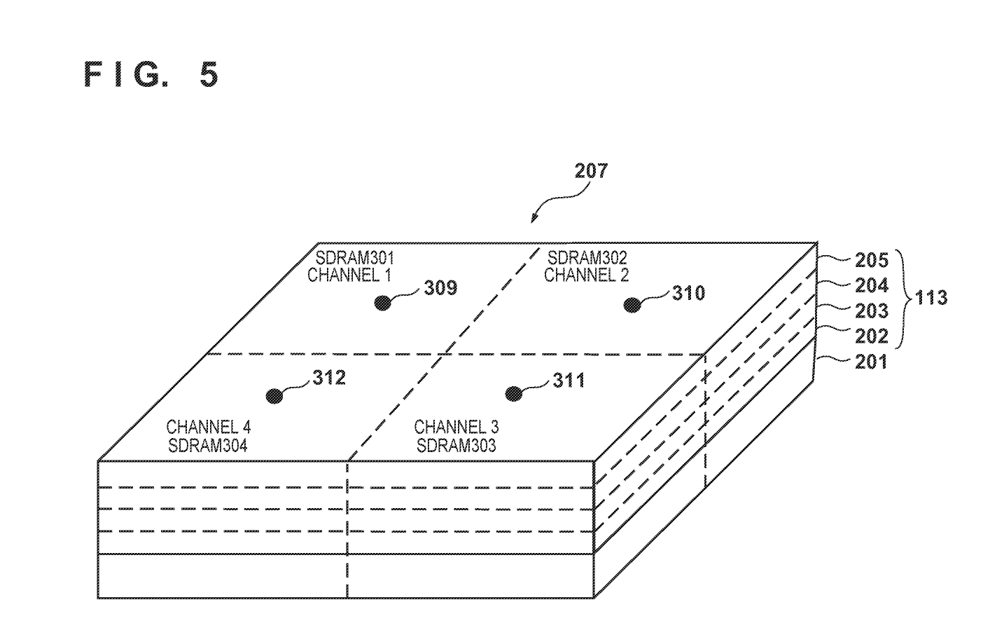

The physical positional relationship between the WideIO-SDRAMs 202 to 205 and SOC die 201 in the SOC package 207 will be described below with reference to FIG. 5. In this embodiment, the SOC die 201 includes the arrangement shown in FIG. 1, that is, blocks except for the LCD display 401, SATA HDD 403, Flash ROM 405, scanner 116, printer engine 117, and WideIO-SDRAM 113 in FIG. 4. Upper left, upper right, lower right, and lower left portions obtained by dividing the plane of the SOC package into four respectively correspond to channels 1 to 4 shown in FIG. 2B. Likewise, these portions correspond to the SDRAMs 301 to 304 in FIG. 3.

The WideIO-SDRAM 113 is a memory stacked on the SOC die 201. In this embodiment, assume that respective devices of the SDRAMs 301 to 304 are stacked on upper portions of areas obtained by dividing the SOC die 201 into four to have a four-layered arrangement, as shown in FIG. 5. The devices of the SDRAMs 301 to 304 respectively integrate the temperature sensors 309 to 312 so as to measure respective memory internal temperatures.

### <Address Map>

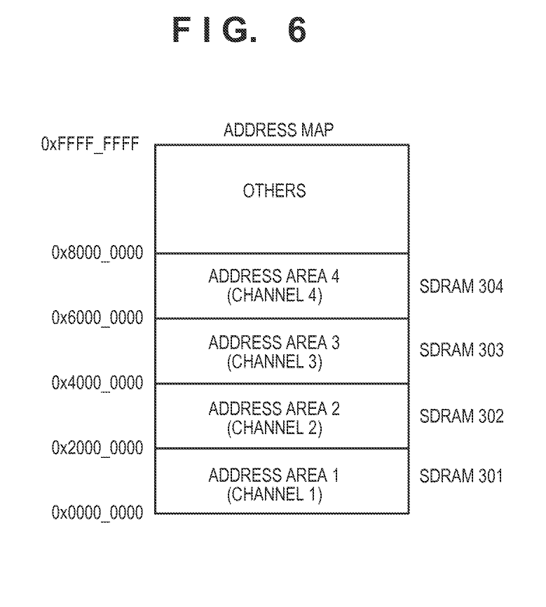

An address map indicating address areas allocated to the SDRAMs 301 to 304 will be described below with reference to FIG. 6. In this embodiment, assume that the SDRAM 301 is allocated with address area 1, the SDRAM 302 is allocated with address area 2, the SDRAM 303 is allocated with address area 3, and the SDRAM 304 is allocated with address area 4, a shown in FIG. 6. That is, channels 1 to 4 in FIG. 5 are respectively allocated to address areas 1 to 4. However, a size of each address area is not limited to that shown in FIG. 6.

<Area Division>

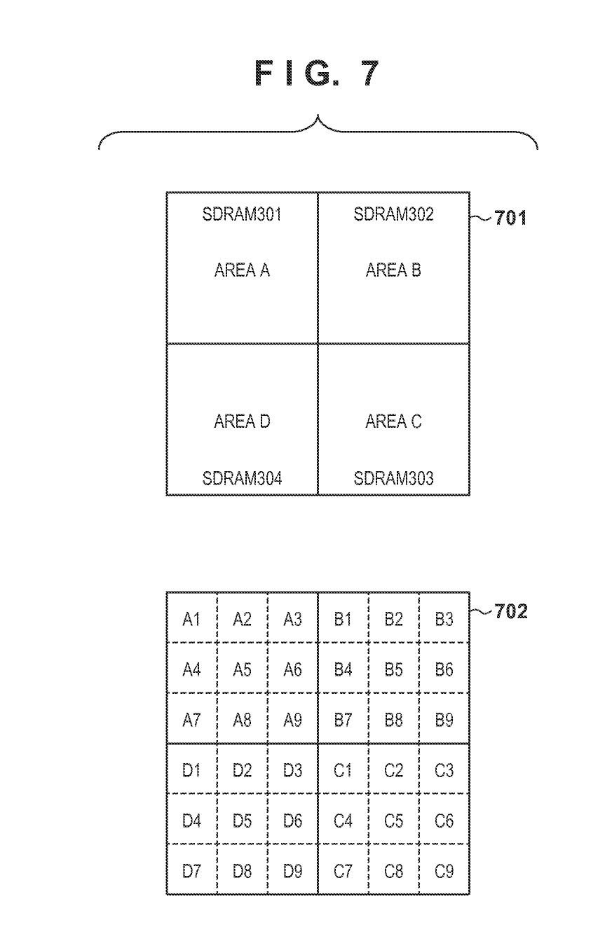

The positional relationship between the devices of the SDRAMs 301 to 304 included in the WideIO-SDRAM 113 and areas obtained when the SOC die 201 is equally divided into 6×6 areas will be described below with reference to FIG. 7. The SDRAMs 301 to 304 are respectively stacked on the upper portions of the areas obtained by dividing the SOC die 201 into four, as described above, and these areas will be referred to as areas A to D, as denoted by reference numeral 701. Each of areas A to D of the SOC die 201 is further divided into 3×3 areas, and these divided areas will be referred to as areas A1 to A9, B1 to B9, C1 to C9, and D1 to D9, as denoted by reference numeral 702. Heat generated by activating these areas is transmitted to the SDRAMs 301 to 304 located on their upper layer portions, thus seriously influencing power consumption and access performance.

<Allocation of Areas>

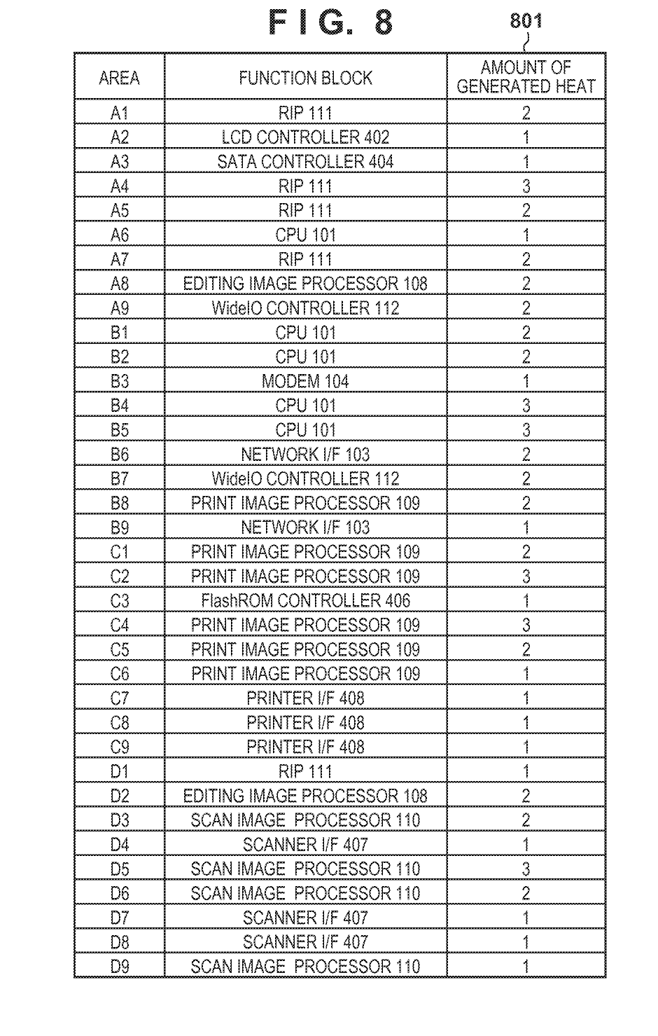

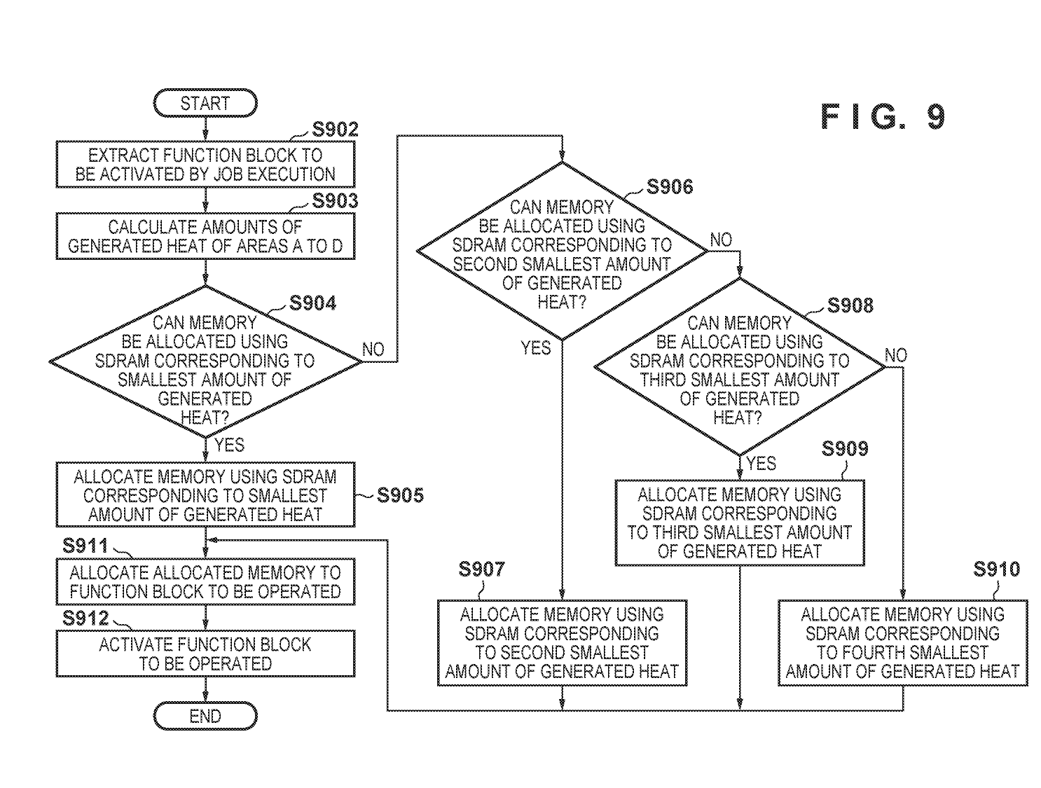

A table 801 which indicates to which of the divided areas 702 in FIG. 7 the respective blocks included in the SOC die 201 are allocated, and relative values of amounts of generated heat upon activating the respective areas will be described below with reference to FIG. 8. As shown in FIG. 8, the table 801 includes pieces of information indicating to which of the areas of the SOC die the plurality of function blocks are allocated, and amounts of generated heat per unit of time upon activating the areas. For example, since the CPU 101 is laid out over areas A6, B1, B2, B4, and B5, and when it is operating, these areas are activated. Then, area A in FIG. 7 generates heat by 1 per unit of time, and area B generates heat by 10 per unit of time.

Also, since the print image processor 109 is laid out over areas B8, C1, C2, C4, C5, and C6, and when it is operating, these areas are activated. Then, area B in FIG. 7 generates heat by 2 per unit of time, and area C generates heat by 11 per unit of time. It is desirable to acquire information of the table 801 in advance upon design of the SOC die 201, and to store that information in the ROM 106 or WideIO-SDRAM 113. More specifically, to which of areas the function blocks in FIG. 1 are allocated is defined using layout information at the time of design of the SOC die 201. Also, amounts of generated heat upon activating the respective areas are defined using heat simulation results at the time of design of the SOC die 201.

In this embodiment, an area with a small amount of generated heat is calculated upon execution of a predetermined job using the layout information of the respective areas and information of amounts of generated heat shown in FIG. 8, and a memory area is allocated to preferentially use the WideIO-SDRAM located on the upper portion of that area. Details of that sequence will be described below.

<Processing Sequence>

The processing sequence for deciding memory areas to be allocated to the image processors operated to execute a copy or print job when the CPU 101 accepts such job from the operation unit 102 or network I/F 103 will be described below with reference to FIG. 9. That is, this flowchart is executed after the CPU 101 accepts the job and before the job is executed. The processing to be described below is executed by the CPU 101 by loading a program developed on any SDRAM of the WideIO-SDRAM 113.

In step S902, when an execution job is input, the CPU 101 extracts function blocks activated upon execution of the job based on execution contents of the job. In step S903, the CPU 101 calculates amounts of generated heat of areas A to D shown in FIG. 7 based on the extracted function block information and the amounts of generated heat per unit of time of the respective areas included in the table 801.

Next, the CPU 101 decides an area with the smallest amount of generated heat from the calculated information of amounts of generated heat of areas A to D, and determines in step S904 whether or not a required memory size can be allocated from the WideIO-SDRAM channel included in that area. If the required memory size can be allocated, the process advances to step S905; otherwise, the process advances to step S906.

In step S905, the CPU 101 allocates an address area allocated to that WideIO-SDRAM channel as an area to be used. On the other hand, if the required memory size cannot be allocated, the CPU 101 decides an area of the second smallest amount of generated heat from the calculated information of amounts of generated heat of areas A to D, and determines in step S906 whether or not a required memory size can be allocated from the WideIO-SDRAM channel included in that area. If the required memory size can be allocated, the process advances to step S907; otherwise, the process advances to step S908.

In step S907, the CPU 101 allocates an address area allocated to that WideIO-SDRAM channel as an area to be used. On the other hand, if the required memory size cannot be allocated, the CPU 101 decides an area of the third smallest amount of generated heat from the calculated information of amounts of generated heat of areas A to D, and determines in step S908 whether or not a required memory size can be allocated from the WideIO-SDRAM channel included in that area. If the required memory size can be allocated, the process advances to step S909; otherwise, the process advances to step S910.

In step S909, the CPU 101 allocates an address area allocated to that WideIO-SDRAM channel as an area to be used. On the other hand, if the required memory size cannot be allocated, the CPU 101 decides an area of the fourth smallest amount of generated heat from the calculated information of amounts of generated heat of areas A to D, and allocates an address area allocated to that WideIO-SDRAM channel as an area to be used in step S910.

In step S911, the CPU 101 sets the address area allocated by the processes of steps S904 to S910 in a register of each of the function blocks which use that memory, so that the function blocks use the memory of that address area. In step S912, the CPU 101 activates the function blocks, and then executes the job.

<Practical Example>

Details of the respective processes of FIG. 9 will be explained below taking a practical example of a job. The following description will be given taking a ScanToBox job which stores scan data in the HDD and a PDLPrint job which prints received PDL data as examples.

The ScanToBox job requires the following processing. That is, scan data input from the scanner I/F 407 is fetched onto the WideIO-SDRAM 113. After that, after the scan image processor 110 executes predetermined image processing, the data is stored in the SATA HDD 403 via the SATA controller 404.

In step S902, the CPU 101 extracts, as function blocks used by the ScanToBox job, the scanner I/F 407, WideIO controller 112, scan image processor 110, SATA controller 404, and CPU 101. Next, the CPU 101 calculates amounts of generated heat of areas A to D using this information and the table 801. When the function blocks extracted in step S902 are operated, areas A3, A6, A9, B1, B2, B4, B5, B7, D3, D4, D5, D6, D7, D8, and D9 are activated based on the information of the table 801. Therefore, in step S903, the CPU 101 calculates A=4, B=12, C=0, and D=11 as relative amounts of heat generated by areas A to D of the SOC die 201 upon execution of the ScanToBox job.

Since area C<area A<area D<area B are determined as areas in ascending order of amount of heat generated by the SOC die 201 upon execution of the ScanToBox job, whether or not a memory can be allocated is determined in this priority order, and the memory is allocated if it can be allocated in steps S904 to S910. For example, when a memory of area C can be allocated, the CPU 101 in step S911 allocates an area of address area 3 in FIG. 6 as an area to be used. Furthermore, since the CPU 101 decides a base address of the memory used by the respective function blocks, it sets the decided address in the aforementioned respective function blocks. Then, the CPU 101 activates the set function blocks in step S912.

A case of the PDLPrint job will be described below. The PDLPrint job requires the following processing. That is, PDL data input from the network I/F 103 is fetched onto the WideIO-SDRAM 113. Next, the RIP 111 rasterizes vector data into raster data, and that data is stored in the SATA HDD 403 via the SATA controller 404. Then, the data is read out from the SATA HDD 403 via the SATA controller 404, and is stored again on the WideIO-SDRAM 113. Finally, after the print image processor 109 executes predetermined image processing, the data is output from the printer I/F 408 to the printer engine 117, thereby printing out the data.

In step S902, the CPU 101 extracts, as function blocks used by the PDLPrint job, the network I/F 103, WideIO controller 112, SATA controller 404, RIP 111, print image processor 109, printer I/F 408, and CPU 101. Next, the CPU 101 calculates amounts of generated heat of areas A to D using this information and the table 801. When the aforementioned function blocks are operated, areas A1, A3, A4, A5, A6, A7, A9, B1, B2, B4, B5, B6, B7, B8, B9, C1, C2, C4, C5, C6, C7, C8, and C9 are activated based on the information of the table 801. Therefore, in step S903, the CPU 101 calculates A=13, B=15, C=14, and D=0 as relative amounts of heat generated by areas A to D of the SOC die 201 upon execution of the PDLPrint job.

Since area D<area A<area C<area B are determined as areas in ascending order of amount of heat generated by the SOC die 201 upon execution of the PDLPrint job, the CPU 101 determines whether or not a memory can be allocated in this priority order, and the memory is allocated in steps S904 to S910. For example, when a memory of area D can be allocated, the CPU 101 allocates an area of address area 4 in FIG. 6 as an area to be used in step S911. Furthermore, since the CPU 101 decides a base address of the memory used by the respective function blocks, it sets the decided address in the aforementioned respective function blocks. Then, the CPU 101 activates the set function blocks in step S912.

As described above, according to this embodiment, function blocks required to be operated to execute a job are extracted, and sum totals of amounts of heat generated upon activation of the respective areas used by the function blocks are calculated. Then, a memory area is preferentially allocated in turn from that of the WideIO-SDRAM corresponding to the small amount of heat. Thus, use of a WideIO-SDRAM channel included in the same area as the SOC area heated by activation can be avoided as much as possible to prevent an abrupt local temperature rise, thus reducing power consumption and suppressing a memory access performance drop.

That is, according to the present invention, when a certain area of the SOC die is activated, a WideIO channel to be used simultaneously with that area can be controlled to preferentially use a memory area of the DRAM, which are located at a position physically far from the area to be activated as much as possible. Thus, a local temperature rise due to an elapse of time can be lightened, and the refresh frequency and leak current of the DRAM can be reduced. Therefore, power consumption can be reduced, and an access performance drop of the WideIO DRAM can be suppressed as much as possible.

### Second Embodiment

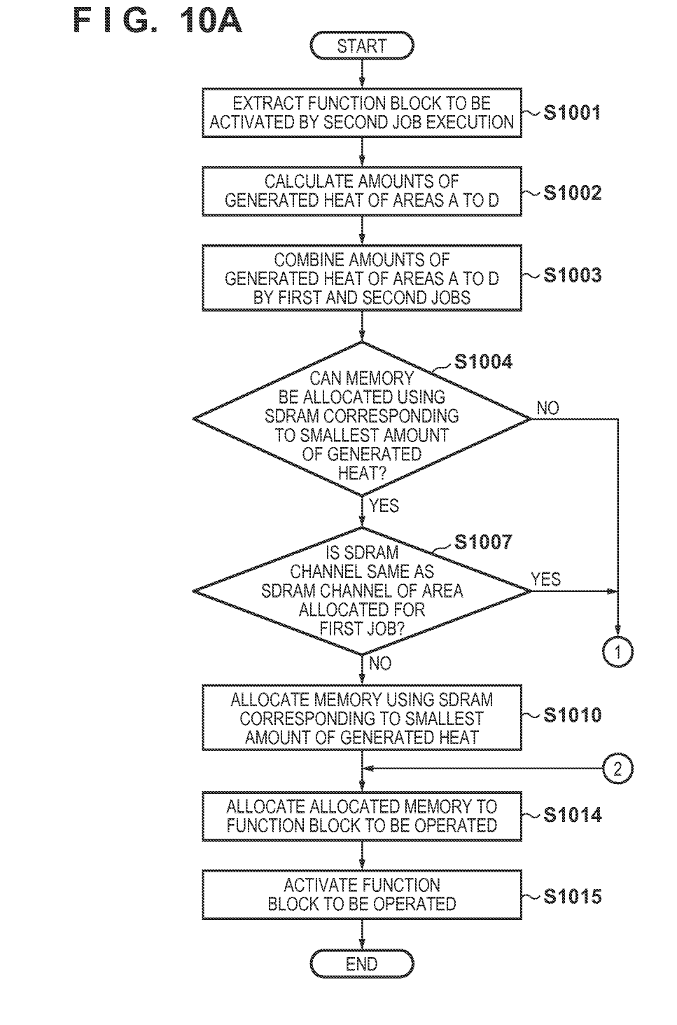

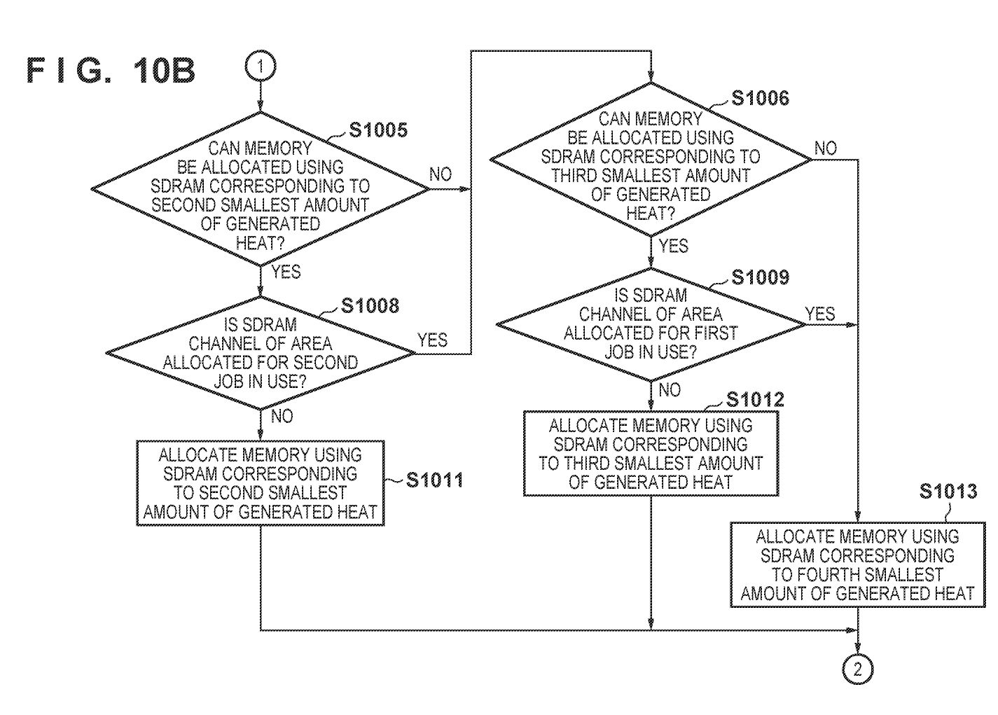

The second embodiment of the present invention will be described below with reference to FIGS. 10A and 10B. In the first embodiment, a WideIO-SDRAM channel (address) to be used is decided to distribute heat generated by respective areas upon execution of a single job. On the other hand, as one feature of an MFP (digital multi functional peripheral) used in the description of the first embodiment, a plurality of jobs can be simultaneously and parallelly processed. In such case, it is unwantedly decided that both jobs use address area 4 (channel 4) corresponding to area D. This suggests that an amount of generated heat of area D is likely to be biased not by heating of a SOC die 201 but by that of WideIO-SDRAM channel 4. In order to solve this problem, in place of deciding a WideIO-SDRAM channel to be used based only on the amounts of generated heat of the SOC die 201, a use state of a WideIO-SDRAM may be additionally taken into consideration.

This embodiment will describe a priority setting method of a WideIO-SDRAM channel to be used upon execution of a plurality of jobs with reference to the flowchart of FIGS. 10A and 10B. The processing to be described below is executed by a CPU 101 by loading a program developed on any SDRAM of a WideIO-SDRAM 113. Initially, upon input of a first job, priorities of WideIO-SDRAM channels are set by the same operation as that described in the first embodiment using FIG. 9. After that, when a second conflict execution job is input, the flowchart of FIGS. 10A and 10B is executed.

In step S1001, the CPU 101 extracts function blocks to be activated upon execution of the input second conflict execution job. Subsequently, in step S1002, the CPU 101 calculates amounts of generated heat of areas A to D shown in FIG. 7 based on the extracted function block information and a table 801. Furthermore, in step S1003, the CPU 101 combines the information of amounts of generated heat of areas A to D for execution of the first job, which are calculated and held in advance, with the amounts of generated heat of areas A to D by the second conflict execution job.

Next, the CPU 101 decides an area corresponding to the smallest amount of generated heat, and determines in step S1004 whether or not a memory size required for an SDRAM channel can be allocated from a WideIO-SDRAM channel included in that area. If the memory size can be allocated, the process advances to step S1007, and the CPU 101 determines whether or not that SDRAM channel is the same as that of an area allocated to execution of the first job. If the SDRAM channels are different, the process advances to step S1010, and the CPU 101 allocates an address area allocated to that WideIO-SDRAM channel as an area to be used.

On the other hand, if the required memory size cannot be allocated in step S1004, or if the SDRAM channel is the same as that of the area allocated to execution of the first job in step S1007, the process advances to step S1005. The CPU 101 decides an area corresponding to the second smallest amount of generated heat from the calculated information of amounts of generated heat of areas A to D, and determines in step S1005 whether or not a required memory size can be allocated from a WideIO-SDRAM channel included in that area. If the required memory size can be allocated, the process advances to step S1008, and the CPU 101 determines whether or not that SDRAM channel is the same as that of an area allocated to execution of the first job. If the SDRAM channels are different, the process advances to step S1011, and the CPU 101 allocates an address area allocated to that WideIO-SDRAM channel as an area to be used.

On the other hand, if the required memory size cannot be allocated in step S1005, or if the SDRAM channel is the same as that of the area allocated to execution of the first job in step S1008, the process advances to step S1006. The CPU 101 decides an area corresponding to the third smallest amount of generated heat from the calculated information of amounts of generated heat of areas A to D, and determines in step S1006 whether or not a required memory size can be allocated from a WideIO-SDRAM channel included in that area. If the required memory size can be allocated, the process advances to step S1009, and the CPU 101 determines whether or not that SDRAM channel is the same as that of an area allocated to execution of the first job. If the SDRAM channels are different, the process advances to step S1012, and the CPU 101 allocates an address area allocated to that WideIO-SDRAM channel as an area to be used.

On the other hand, if the required memory size cannot be allocated in step S1006, or if the SDRAM channel is the same as that of the area allocated to execution of the first job in step S1009, the process advances to step S1013. In step S1013, the CPU 101 decides an area corresponding to the fourth smallest amount of generated heat from the calculated information of amounts of generated heat of areas A to D, and allocates that area as that to be allocated to the second conflict execution job.

Since processes of steps S1014 and S1015 are the same as those of steps S911 and S912 in FIG. 9, a description thereof will not be repeated.

Details of the respective processes will be described below taking practical examples of jobs. This embodiment will explain two cases in which either of a ScanToBox job and PDLPrint job is input first in association with a WideIO-SDRAM channel priority setting method when these jobs described in the first embodiment are operated in conflict with each other.

A case will be explained first wherein the ScanToBox job is input first, and the PDLPrint job is then input to cause an operation conflict. The WideIO-SDRAM channel priority setting method when the ScanToBox job is input has already been described in the first embodiment, and address area 3 (channel 3) corresponding to area C is used. Next, processing executed when the PDLPrint job is operated as a conflict execution job to the ScanToBox job will be described below.

In step S1001, the CPU 101 extracts function blocks used in the PDLPrint job as a second conflict execution job. Furthermore, in steps S1002 and S1003, the CPU 101 calculates amounts of generated heat of areas A to D upon execution of the second conflict execution job, and a total of the amounts of generated heat of the two jobs. More specifically, as can be seen from the information of the table 801, when function blocks used by the ScanToBox job and PDLPrint job are operated, areas A1, A3 to A9, B1, B2, B4 to B9, C1, C2, C3 to C9, and D3 to D9 are activated. Therefore, relative amounts of heat generated on areas A to D of the SOC die 201 as a result of the conflict operations of these two jobs are respectively calculated as A=13, B=15, C=14, and D=11.

Therefore, when the PDLPrint job input later is operated as a conflict to the ScanToBox job input earlier, the CPU 101 determines address area 4 (channel 4) corresponding to area D as a first candidate in step S1004. If the CPU 101 determines that address area 4 can be allocated, since this address area is different from that allocated for the ScanToBox job input earlier, address area 4 is allocated intact to the PDLPrint job.

A case will be described below wherein the PDLPrint job is input first, and the ScanToBox job is then input to cause an operation conflict. The WideIO-SDRAM channel priority setting method when the PDLPrint job is input has already been described in the first embodiment, and address area 4 (channel 4) corresponding to area D is used. Next, processing executed when the ScanToBox job is operated as a conflict execution job to the PDLPrint job will be described below.

In step S1001, the CPU 101 extracts function blocks used in the ScanToBox job as a second conflict execution job. Furthermore, in steps S1002 and S1003, the CPU 101 calculates amounts of generated heat of areas A to D upon execution of the second conflict execution job, and a total of the amounts of generated heat of the two jobs. More specifically, as can be seen from the information of the table 801, when function blocks used by the ScanToBox job and PDLPrint job are operated, areas A1, A3 to A9, B1, B2, B4 to B9, C1, C2, C3 to C9, and D3 to D9 are activated. Therefore, relative amounts of heat generated on areas A to D of the SOC die 201 as a result of the conflict operations of these two jobs are respectively calculated as A=13, B=15, C=14, and D=11.

Therefore, when the ScanToBox job input later is operated as a conflict to the PDLPrint job input earlier, the CPU 101 determines address area 4 (channel 4) corresponding to area D as a first candidate in step S1004. If the CPU 101 determines that address area 4 can be allocated, this address area is the same as that allocated for the PDLPrint job input earlier. In order to avoid heating of the memory device itself from using the same area as a result of job conflict, the CPU 101 determines address area 1 (channel 1) corresponding to area A as a second candidate as an area to be allocated to the ScanToBox job in step S1005. In this case, when the CPU 101 determines that address area 1 can be allocated, since this address area is different from that allocated for the PDLPrint job input earlier, address area 1 is allocated intact to the ScanToBox job.

As described above, according to this embodiment, even when a plurality of jobs are simultaneously and parallelly executed, an abrupt local temperature rise due to concentrated use of a memory device of the same area (channel) can be precisely prevented. Hence, power consumption can be reduced, and a memory access performance drop can be suppressed.

### Third Embodiment

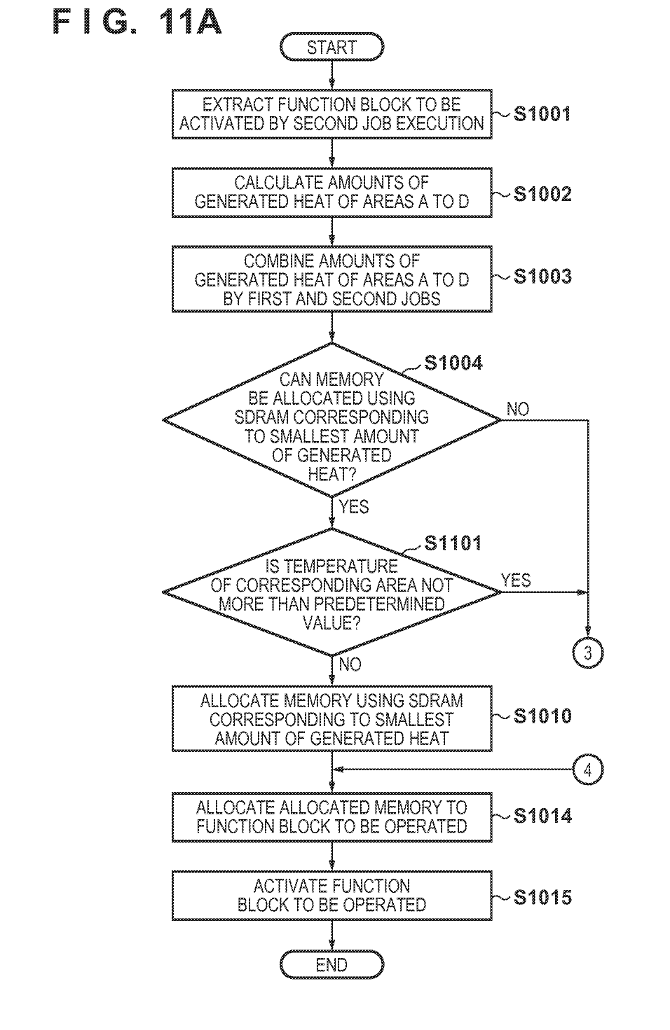

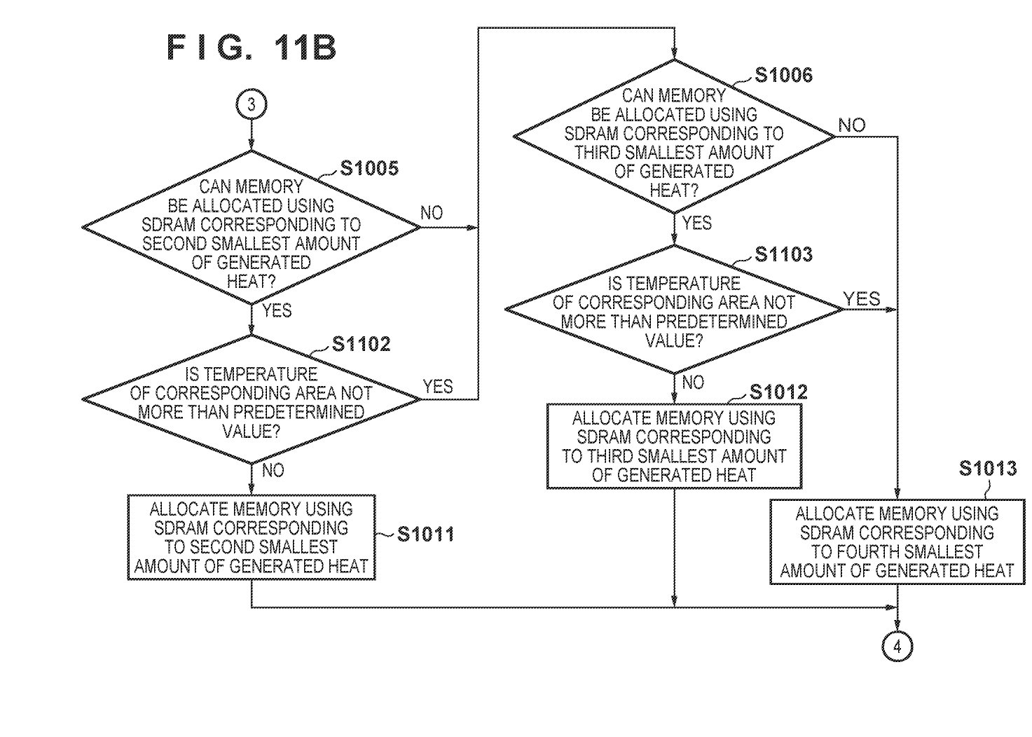

The third embodiment of the present invention will be described below with reference to FIGS. 11A and 11B. As one priority setting method of a channel to be used upon execution of a conflict, the second embodiment controls not to use the same channel as a channel used by a job input earlier as much as possible for the conflict input later.

In order to solve the problem upon execution of a conflict, a channel to be used may be judged additionally in consideration of temperatures of areas. This embodiment will explain a priority setting method of a WideIO-SDRAM channel to be used additionally in consideration of temperature information of respective areas upon execution of a plurality of jobs with reference to the flowchart of FIGS. 11A and 11B. Assume that this flowchart will explain only differences from the processing shown in FIGS. 10A and 10B, and processes other than those to be described below are the same as the second embodiment.

In the second embodiment, after a use channel candidate, an area of which can be allocated, is decided in steps S1004 to S1006, whether or not the decided channel candidate is an area used by a first job input earlier is determined in steps S1007 to S1009. On the other hand, in this embodiment, in place of determination as to whether or not the decided channel candidate is an area used by a first job input earlier, the temperature of the corresponding area is measured by the temperature sensors 309 to 312. Then, the CPU 101 determines in steps S1101 to S1103 whether or not the temperature value is not more than a predetermined value, and determines based no this determination result whether or not the use channel candidate is allocated. Thus, a heating state of the first job input earlier can be recognized with high precision, and a channel to be used can be controlled based on the measurement result.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-261626 filed on Nov. 29, 2012, which is hereby incorporated by reference herein in its entirety.

1. An information processing apparatus, which comprises a WideIO memory device stacked on a SOC die including a CPU, said apparatus comprising:
an accepting unit configured to accept a job;
a calculation unit configured to calculate amounts of generated heat of respective areas of a plurality of areas of the SOC die when one or more function blocks required to execute the job accepted by said accepting unit are operated; and
a memory control unit configured to preferentially allocate a memory area of the WideIO memory device stacked on a corresponding area to the function blocks to be operated in accordance with an order of areas corresponding to smaller amounts of generated heat calculated by said calculation unit.

2. The apparatus according to claim 1, wherein said memory control unit determines whether or not a memory required for the function blocks to be operated can be allocated in the order of areas corresponding to the smaller amounts of generated heat calculated by said calculation unit, and allocates an area which can allocate the required memory and corresponds to the smallest amount of generated heat to the function blocks to be operated.

3. The apparatus according to claim 1, wherein when said accepting unit accepts a plurality of jobs, and the plurality of jobs are parallelly executed,
said memory control unit determines whether or not a memory required for the function blocks to be operated can be allocated in the order of areas corresponding to the smaller amounts of generated heat calculated by said calculation unit, and allocates an area which can allocate the required memory, is not allocated to another job, and corresponds to the smallest amount of generated heat to the function blocks to be operated.

4. The apparatus according to claim 1, further comprising a sensor configured to measure temperatures of respective areas,
wherein when said accepting unit accepts a plurality of jobs, and the plurality of jobs are parallelly executed,
said memory control unit determines whether or not a memory required for the function blocks to be operated can be allocated in the order of areas corresponding to the smaller amounts of generated heat calculated by said calculation unit, and allocates an area which can allocate the required memory, a temperature value measured by said sensor of which is not more than a predetermined value, and which corresponds to the smallest amount of generated heat to the function blocks to be operated.

5. The apparatus according to claim 1, further comprising a table including information indicating an allocation relationship between the plurality of function blocks and areas of the SOC die, and amounts of generated heat per unit of time upon activating the respective areas,
wherein said calculation unit calculates the amounts of generated heat of the respective areas with reference to said table.

6. The apparatus according to claim 5, wherein said table is defined using layout information at the time of design of the SOC die and heat simulation results.

7. A control method of an information processing apparatus, which comprises a WideIO memory device stacked on a SOC die including a CPU, the method comprising:
controlling an accepting unit to accept a job;
controlling a calculation unit to calculate amounts of generated heat of respective areas of a plurality of areas of the SOC die when one or more function blocks required to execute the job accepted in the controlling the accepting unit are operated; and
controlling a memory control unit to preferentially allocate a memory area of the WideIO memory device stacked on a corresponding area to the function blocks to be operated in accordance with an order of areas corresponding to smaller amounts of generated heat calculated in the controlling the calculation unit.

8. A non-transitory computer-readable storage medium storing a computer program for controlling a computer to execute respective steps in a control method of an information processing apparatus according to claim 7.
